(19) United States
(12) Patent Application Publication
(10) Pub. No.: US 2009/0192934 A1
(43) Pub. Date: Jul. 30, 2009

(54) Consumer Lending Using A Money Transfer Network Systems And Methods

(75) Inventors: Lau Kam Chu, Chaiwan (HK); Cheung Pik Wa, North Point (HK); Yung Miu Chu, Lei King Wan (HK); Stuart Davis, Castle Rock, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Western Union Company, Englewood, CO (US)

(21) Appl. No.: 12/058,973

(22) Filed: Mar. 31, 2008

Related U.S. Application Data
(60) Provisional application No. 61/024,797, filed on Jan. 30, 2008.

(51) Int. Cl. G06Q 40/00

(52) U.S. Cl. 705/38; 705/39

(57) ABSTRACT

A method of lending money includes receiving a loan application from a consumer. The consumer is a prior customer of a money transfer service provider. The method also includes using information indicative of the consumer's prior usage of services provided by or through the money transfer service provider to approve the loan application. The method further includes using a money transfer network to provide loan proceeds to the consumer or a designee of the consumer and/or transfer loan payments associated with the loan application. In some embodiments using information indicative of the consumer's prior usage of services provided by or through the money transfer service provider to approve the loan application includes approving the loan in the absence of a credit report on the consumer. The method also my include using the consumer's usage history of pre-paid accounts serviced by the money transfer service provider to approve the loan application.

### CROSS-REFERENCES TO RELATED APPLICATIONS

This application is a non-provisional, and claims the benefit, of commonly assigned U.S. Provisional Application No. 61/024,797, filed Jan. 30, 2008, entitled “Consumer Lending And Money Transfers,” the entirety of which is herein incorporated by reference for all purposes.

### FIELD OF THE INVENTION

This disclosure relates generally to consumer lending and, more specifically, to consumer loans coupled with money transfers amongst other things.

### BACKGROUND

Consumer lending is big business. Many individuals avail themselves of loans provided by a variety of financial institutions. Many potential consumers, however, are unable to obtain consumer loans for a variety of reasons. Some have not established credit worthiness, at least according to how that term is generally understood.

Credit worthiness typically is recognized once an individual has established a track record of repaying debt. In some cases, individuals who are able to demonstrate a regular source of income may be considered creditworthy despite not having developed a repayment track record, provided they have not been identified as a bad credit risk for other reasons. But these traditional tests of credit worthiness tend to eliminate a large group of individuals who are otherwise credit worthy. A common thread within this potential market is that these individuals do not have a traditional banking relationship. Such individuals may be identified by their use of financial products and/or services that do not require a banking relationship, such as pre-paid cards and money transfer services. Hence, systems and methods are needed that target this underserved market.

### SUMMARY

Embodiments of the present invention provide a method of administering a loan. The method includes determining to approve a loan application for the loan to a consumer; using a money transfer network to make loan proceeds associated with the loan available to a recipient of the loan; and paying out at least a portion of the loan proceeds to the recipient.

In some embodiments using the money transfer network to make loan proceeds associated with the loan available to the recipient occurs at any of a plurality of money transfer agent locations, wherein a money transfer agent location comprises a physical location at which senders provide funds for transfer to receivers and/or receivers receive funds transferred from senders. Paying out at least a portion of the loan proceeds to the recipient may occur at one of the plurality of money transfer agent locations. Determining to approve a loan application for a loan to a consumer may include using alternative criteria to underwrite the loan, the alternative criteria including data indicative of the consumer's past usage of non-credit products or services. Determining to approve a loan application for a loan to a consumer may include determining to approve the loan application for the loan to the consumer in the absence of a credit score relating to the consumer. The recipient may be the consumer. The recipient may be an individual other than the consumer. The method may include receiving the loan application at a first money transfer agent location and paying out the loan proceeds at a second money transfer agent location. The first money transfer agent location and the second money transfer agent location may be the same location. The method may include thereafter, receiving a loan payment into the money transfer network; and transferring at least a portion of the loan payment using the money transfer network to a lender of the loan proceeds. The third money transfer agent location may be a different money transfer agent location than either the first money transfer agent location or the second money transfer agent location.

Other embodiments provide a method of lending money to a consumer using a money transfer network. The method includes receiving a loan application from the consumer. Receiving the loan application may include entering information from the loan application into a computer system, the information at least including identifying information that identifies the consumer; using the identifying information to search stored data and extract prior usage data indicative of the consumer's prior use of the money transfer network; using the prior usage data to, at least in part, approve the loan application; introducing loan proceeds associated with the loan application into the money transfer network for receipt by a recipient; and paying out at least a portion of the loan proceeds to the recipient.

In some embodiments receiving the loan application from the consumer occurs at a first money transfer agent location, and introducing loan proceeds associated with the loan application into the money transfer network for receipt by a recipient occurs at a second money transfer agent location. The first money transfer agent location and the second money transfer agent location may be the same location. The first and second money transfer agent locations may be in different countries. The method may include thereafter, receiving a loan payment at a third money transfer agent location; and transferring at least a portion of the loan payment using the money transfer network to a lender of the loan proceeds. The third money transfer agent location may be a different money transfer agent location than either the first money transfer agent location or the second money transfer agent location.

Still other embodiments provide a method of lending money. The method includes receiving a loan application from a consumer. The consumer may be a prior customer of a money transfer service provider. The method also includes using information indicative of the consumer's prior usage of services provided by or through the money transfer service provider to approve the loan application. The method further includes using a money transfer network to provide loan proceeds to the consumer or a designee of the consumer and/or transfer loan payments associated with the loan application.

In some embodiments using information indicative of the consumer's prior usage of services provided by or through the money transfer service provider to approve the loan application includes approving the loan in the absence of a credit report on the consumer. The method also my include using the consumer's usage history of pre-paid accounts serviced by the money transfer service provider to approve the loan application.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows block diagram of an exemplary lending and money transfer system according to one embodiment of the invention.

FIG. 2 shows a flowchart of an exemplary method for providing consumer loans and transferring at least a portion of the consumer loans to a third party according to one embodiment of the invention.

FIG. 3 shows a flowchart of an exemplary method for providing payment on a consumer loan through a money transfer network according to one embodiment of the invention.

FIG. 4 shows a flowchart of an exemplary method for providing consumer loans and transferring at least a portion of the consumer loans to a third party according to one embodiment of the invention.

### DETAILED DESCRIPTION

Embodiments of the present invention relate to systems and methods for providing consumer loans. In some embodiments, underwriting decisions are based on alternative criteria to be described more fully hereinafter. In some embodiments, loan proceeds are paid out via a money transfer network. Similarly, installment payments on the loan are made using a money transfer network. Hence, although not necessary to the present invention, embodiments of the present invention will be described herein with reference to consumer loans that utilize a money transfer network, in order to provide a context for the ensuing description. A money transfer network may be a network of locations (e.g., physical, electronic, telephonic) where any form of value may be transmitted by a consumer or received by a recipient, or a money transfer network may be a money transmitter or other person, entity, organization or association that operates a money transfer network.

Accordingly, the ensuing description provides preferred exemplary embodiment(s) only and is not intended to limit the scope, applicability or configuration of the disclosure. Rather, the ensuing description of the preferred exemplary embodiment(s) will provide those skilled in the art with an enabling description for implementing a preferred exemplary embodiment. It should be understood that various changes may be made in the function and arrangement of elements without departing from the spirit and scope as set forth in the appended claims.

Specific details are given in the following description to provide a thorough understanding of the embodiments. However, it will be understood by one of ordinary skill in the art that the embodiments may be practiced without these specific details. For example, systems may be shown in block diagrams in order not to obscure the embodiments in unnecessary detail. In other instances, well-known processes, structures and techniques may be shown without unnecessary detail in order to avoid obscuring the embodiments.

Embodiments of the present invention provide methods and systems for accepting loan applications, approving and/or denying loan applications; providing consumer loans based on approved applications and transferring a portion or an entire loan to a recipient through a money transfer network. A recipient may be a third-party, such as another individual or an organization (e.g., a merchant, a collection agency, a government agency, a not-for-profit, etc.) or the consumer and the recipient may be the same person. The recipient may withdraw and/or receive the loan at 1) an agent location of the money transfer network, 2) a bank account, 3) a stored value card or account, 4) a prepaid card or account, 5) a debit card or account, 6) a credit card or account, 7) an investment account, and/or 8) a smart card. The loan may also be received in an account that is accessible online and/or using mobile presentation instrument(s) and/or a mobile device(s). Moreover, embodiments of the invention may also provide for accepting loan payments at or sending loan payments from an agent location of the money transfer network. Loan payments can also be made through the Internet (website, e-mail, e-bill presentment and payment), by telephone, via a mobile device, at a kiosk, at an automated teller machine (“ATM”), or text message. Payments may be made in cash, credit card or account, debit card or account, prepaid card or account, automated clearing house (“ACH”), stored value card or account, smart card, investment account, check, money order, and/or traveler's check.

For example, an immigrant worker may wish to quickly transfer money to a family member in need that is in another country. The immigrant worker may also have a history of sending money transfers through a money transmitter and/or money transfer network, such as, for example, the well-known money transfer network of Western Union of Englewood, Colo. While the immigrant worker may not have the funds currently at their disposal, they may wish to apply for a loan. A lending institution may be associated with a money transfer network and may have access to the money transfer network's customer databases and/or files. A money transmitter or money transfer network may have access to the lending institution's customer databases and/or files. The lending institution may approach the immigrant worker, be approached by the immigrant or be referred by the money transfer network for a loan. The immigrant worker may then apply for a loan from the lending institution. In one embodiment, the lending institution may approve or deny a loan, based in part on information provided by the money transfer network. Information that may be provided by a money transmitter or money transfer network can include information relating to the consumer, the recipient or both and may include past history information, including without limitation, the length of time the person has transacted with the money transfer network, the number of transactions sent or received, the principal amounts sent or received, fees paid, the mix of products and/or services used, and whether or not the person is a member of a loyalty program. Additionally, or in the alternative, information that may be provided may include a customer risk score and/or a credit rating or credit score. The loan application may also depend on various other factors. The loan, for example may be an installment loan according to one embodiment of the invention. According to another embodiment of the invention the loan may have a term from 6 to 18 months, for example 12 months.

If a loan is approved, the lending institution may transfer all or a portion of the loan amount to the immigrant worker's family through the money transfer network. The immigrant worker's family may receive the transferred funds at an agent location of the money transfer network. Moreover, any party may make payments on the loan at an agent location of the money transfer network. The loan may also be made available through a “loan card” that may be in the form of a set denomination or variable denomination. The loan card may be made available to the recipient at an agent location and/or at a branch of the lending institution. Additionally, a loan card may be ordered online. In some embodiments, the loan card would not be an activated (or “live”) card prior to the loan being approved, but live loan cards also could be used without deviation from the scope and spirit of the invention. If a loan card is not live until the loan has been approved, various methods could be used to make the card a live card, including, without limitation, activating the card through the use of a point-of-sale device in communication with the money transfer network and/or the lending institution. After a recipient obtains an activated loan card, the recipient may use the loan card and/or a number and/or PIN associated with the loan card to obtain funds from an ATM, kiosk, agent location, and/or lending institution or to pay for goods or services. The loan card can be read by any suitable means, including without limitation, by means of a magnetic stripe, bar code, and/or a chip.

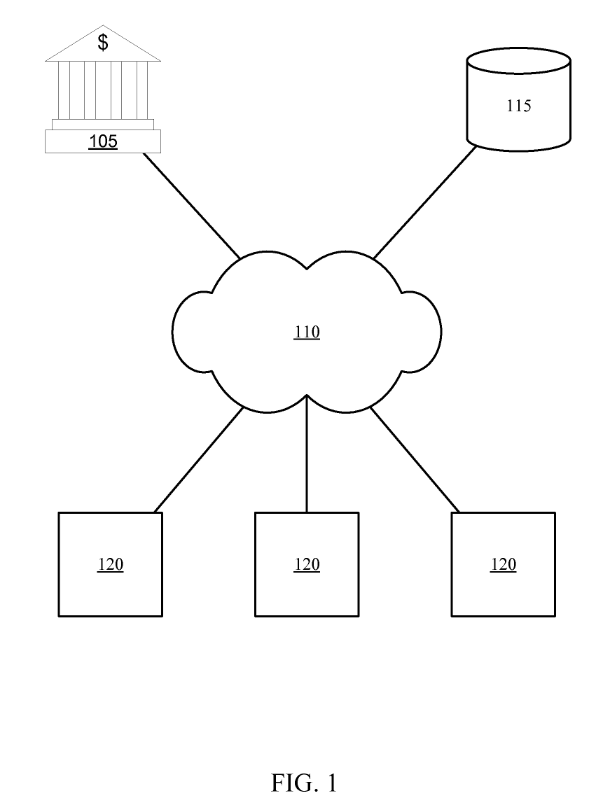

FIG. 1 shows block diagram of an exemplary lending and money transfer system according to one embodiment of the invention. A lending institution 105, such as, for example, a bank, a credit union, credit card company, etc., may be coupled with or in communication with a money transfer network 110. The lending institution may be associated with the money transfer network 110. Moreover the money transfer network 110 and the lending institution 105 may be the same institution or under the same ownership. For example, the lending institution may be a subsidiary or affiliate of the money transfer network. The money transfer network 110 may include one or more databases 115 that includes customer information that is at least partially or wholly accessible by the lending institution 105 and may include past history information relating to usage of the money transfer network by customers, a customer risk score and/or a credit rating or credit score. A number of money transfer agent locations 120 are also coupled with and/or comprised by the money transfer network 110. These agent locations 120 may be located in various locations around the world. Other transaction channels permitting access to the money transfer network may include Internet (website, e-mail, e-bill presentment and payment), telephones, IVR/VRU, mobile devices, kiosks, and ATMs.

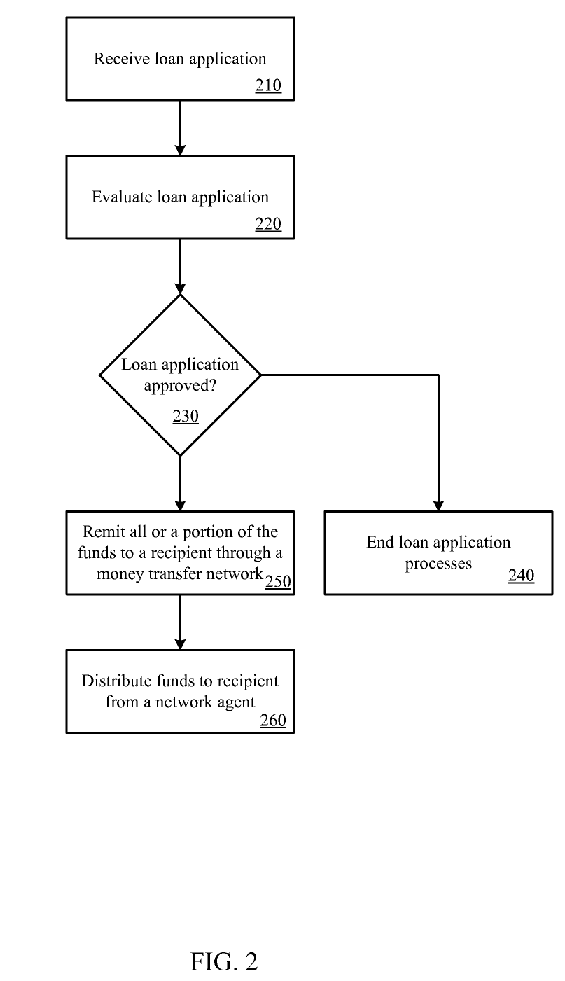

FIG. 2 shows a flowchart of an exemplary method for providing consumer loans and transferring at least a portion of the consumer loans to a third party according to one embodiment of the invention. The method may be implemented in the system of FIG. 1 or other appropriate system. Those skilled in the art will appreciate that other methods according to other embodiments may include more, fewer, or different steps than those illustrated and described herein. According to this exemplary method, a loan application is received at the lending institution at block 210 and evaluated at block 220. During the loan application process the consumer may be required to submit identifying information such as, for example, a driver's license, social security card, social security number, passport, bank information, government ID, proof of employment, credit card number, bank account number, employment contract, security card, loyalty card or number, telephone number, wireless number, e-mail address, proof of address (e.g., utility or other bill) and/or some other identifier such as, for example, user name and/or password. The information may be presented as one or more numerals, letters, alpha-numeric characters, biometric features (e.g., fingerprint, voiceprint, facial recognition, retina recognition), bar codes, and magnetic ink and may be read by a person or by one or more machines through, for example, radio frequency, magnetic stripe, chipset, voice recognition, dual-tone multi-frequency (DTMF) signal, optical scanning or any combination of the foregoing. Various other forms and/or types of information may also be provided. A decision on the loan application is made at block 230.

The decision may be made on any number of factors, including past history with the money transfer network. In some embodiments, the loan application may be approved without further information provided by the consumer, and/or based on information held by the money transfer network and/or information held by the lending institution. Further details regarding such alternative loan approval standards are described in greater detail below following the description of FIG. 2.

If the loan application is denied, the application process ends at block 240. Otherwise, a portion or all of the loan amount may be transferred to a recipient through the money transfer network at block 250. A fee may be levied by the money transfer network and/or the lending institution according to one embodiment of the invention. In other embodiments, the fee may be paid by the lending institution and may include a percentage of the loan amount, a fixed fee or a portion of the interest payments on the loan. The funds may then be distributed to the recipient at block 260 at 1) an agent location, 2) a bank account, 3) a stored value card or account, 4) a prepaid card or account, 5) a debit card or account, 6) a credit card or account, 7) an investment account, 8) a smart card and/or 9) a mobile wallet. The recipient may access and use the funds, for example, using a mobile device.

According to exemplary embodiments, a loan application may be underwritten using non-traditional criteria. Such criteria may include a “consumer risk score” that may not take into consideration the applicant's credit history or score or may consider data that supplements an applicant's credit history or score. Conventional lending considers a borrower's ability to repay and is typically based on a credit report, credit scoring, or a financial statement review which is used to perform a cash flow analysis. What this fails to consider is other methods of evaluating a customer's riskiness based on activities in non-credit products.

Transactional, derivative and related data from non-credit products such as prepaid cards and money transfers can provide a strong proxy for traditional credit data and credit analysis, especially in situations where traditional credit related data (such as credit reports and financial statements) are not available.

Embodiments of the present invention may use a suitable proxy to a credit score, herein referred to as a customer risk score, to underwrite loan applications. The consumer risk score may be derived from many factors within at least three categories of evaluation that may include, for example: (1) Transactional data—data related to a consumer's transactions in certain non-credit products; (2) Derivative data—data that is derivable from traditional transaction data such as velocity of funds; and (3) Related data—data factors related to the specifics of the relationship such as duration of account, fees paid, and enrollment in premium features. These categories are described in greater detail hereinafter.

Transactional data may include data related to an applicant's prior use of money transfer services, prepaid cards, and the like. For prepaid cards, possibilities include: funding patterns (how often is account funded, how much is account funded, etc.); source of funding (cash, direct deposit, money transfer, etc.); spending patterns (how often is an amount spent, how much is spent, etc.); and the like. For money transfers, possibilities include: amount of transfers sent; how often are transfers sent; amount of transfers received; how often are transfers received; funding methods for sent transfers (e.g., cash, prepaid, credit card, money order, debit, check); payout methods for received transfers (cash, prepaid, credit card, money order, debit, check, etc.); and the like.

Derivative data can be based on data derived from transactional data or transaction records, specifically transactional data related to money transfer activity, prepaid card activities, and the like. For prepaid cards, data may include spending riskiness, which could include evaluating merchant codes related to spending transactions. Different merchant codes would be risk scored based on nature of typical purchases. For example a cell phone merchant code would be viewed as less risky than a travel agent merchant code. If a consumer's transactions were generally with lower risk merchants then this factor would be more favorable than a consumer whose transactions were with high risk merchants. Other factors could include average account balance, average size of transactions, velocity of funds, and the like. For money transfers, data may include consistency risk, which may include evaluating and scoring the consistency of a series of transactions. For example a consistent sender and a consistent receiver (less risk) versus inconsistent senders and receivers (more risk). Other possibilities include average transfer amount, number of transfers, velocity over time of funds sent and/or received, and the like.

Related data can include data related to money transfer activity, prepaid card activities, and the like. For prepaid, possibilities include duration of the account, amount of fees paid, duration of activity; enrollment in a preferred program or premium options or features; online usage, and the like. For money transfers, possibilities include length of time transacting; average speed to pickup, business or personal transfers; fees paid (transfer fees and/or foreign exchange fees), fraud instances; transacting corridors (higher or lower risk may be associated with transacting in certain corridors), enrollment in a preferred program or premium options or features, and the like.

Any of the above factors could be risk scored and/or statistically evaluated to provide a reasonable proxy for credit or for the offering of other products or services.

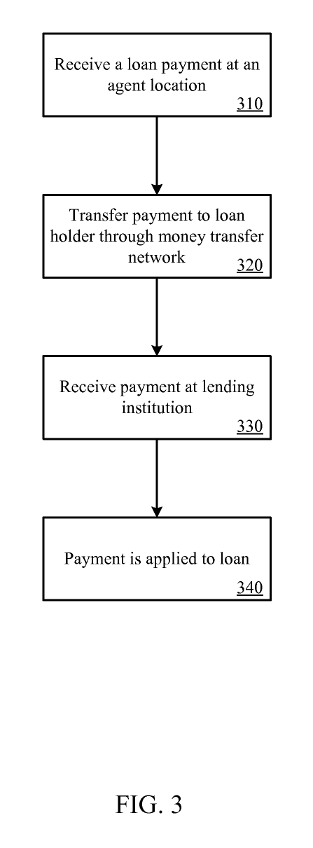

FIG. 3 shows a flowchart of an exemplary method for providing payment on a consumer loan through a money transfer network according to embodiments of the invention. Any individual, including the borrower and/or the recipient of the funds, may make a loan payment at an agent location at block 310. Payments may also be made via Internet (e.g., website, e-mail, e-bill presentment and payment), by telephone, by IVR/VRU, via a mobile device, at a kiosk, at an automated teller machine (“ATM”), or text message. Loan payments may require payment of a fee by the sender to the money transfer network, the lending institution or both, or to the operator(s) of one or more telephone networks, mobile networks, kiosks, ATMs, or Internet services. In some cases, the principal amount sent and/or the fee may be placed into an interim account prior to the money transfer network receiving the principal amount and/or the fee. The funds may be transferred to the lending institution at block 320, received at the lending institution at block 330 and applied to the loan at block 340.

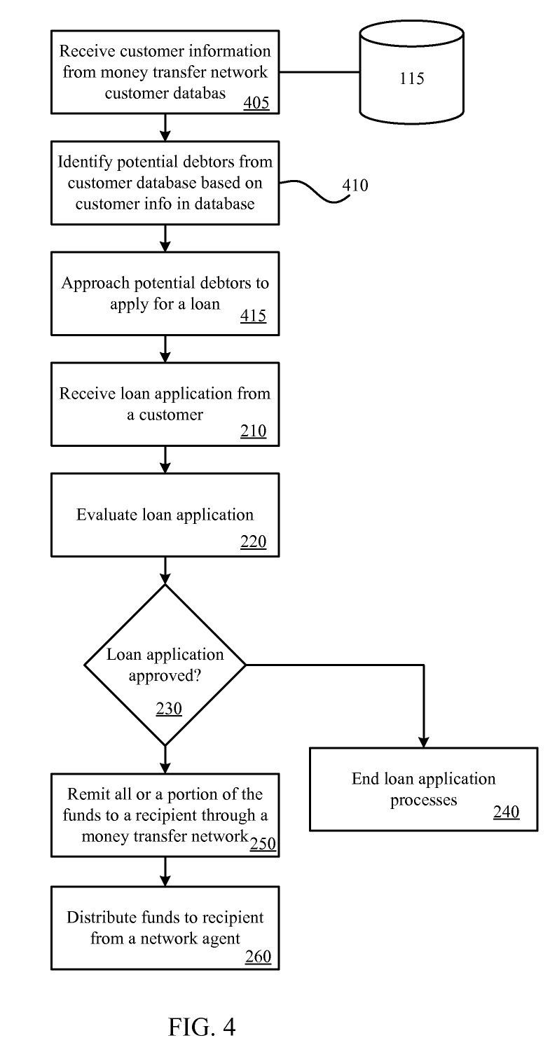

FIG. 4 shows a flowchart of an exemplary method for providing consumer loans and transferring at least a portion of the consumer loan(s) to a recipient according to one embodiment of the invention. Information, such as, for example, customer information, past history, number of previous transactions at the money transfer network, average transaction amount at the money transfer network, products and/or services used at the money transfer network and/or at a third-party, fees paid to the money transfer network, loyalty program(s) associated with the customer, length of time the customer has been using the money transfer network, frequency of the customer's use of the money transfer network, customer risk score and/or credit rating or credit score is received at the lending institution from the money transfer network at block 405. The information may be stored in one or more local or remote databases 115. Based on this information, potential debtors may be identified at block 410 and approached to apply for a loan at block 415. From this point the flowchart is similar to the flowchart shown in FIG. 2.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Transactions may be processed by one or more personal computers, host computers and/or server computers. These computers may be maintained centrally, regionally, or globally by the money transfer network. Computers and/or other devices (e.g., mobile devices), in communication with the money transfer network, may be used at an agent, an agent location, a consumer's home or work, a recipient's home or work and/or a lending institution to implement embodiments of the invention. Such computers may be configured with an operating system including any commercially-available server operating systems, minicomputer operating systems and/or mainframe operating systems. Such computers may also run one or more applications, which can be configured to provide services in furtherance of embodiments of the invention, including without limitation performance of methods of the invention (and/or various operations thereof), as well as traditional transaction processing and/or banking operations.

A computer system may further include (and/or be in communication with) one or more storage devices, such as the storage device 115 shown in FIG. 1, which can comprise, without limitation, local and/or network accessible storage and/or can include, without limitation, a disk drive, a drive array, an optical storage device, solid-state storage device such as a random access memory (“RAM”) and/or a read-only memory (“ROM”), which can be programmable, flash-undatable and/or the like. A computer system might also include a communications subsystem; which can include without limitation a modem, a network card (wireless or wired), an infra-red communication device, and/or the like, a wireless communication device and/or chipset (such as a Bluetooth™ device, an 802.11 device, a WiFi device, a WiMax device, cellular communication facilities (e.g., Global System for Mobile Communications, Code Division Multiple Access, and/or Time Division Multiple Access), etc.). The communications system may permit data to be exchanged with a network (such as the network described below, and/or any other devices described herein). In many embodiments, the computer system will further comprise a memory, which can include a RAM or ROM device, as described above.

Certain embodiments of the invention operate in a networked environment, which can include a network such as, for example, a money transfer network. The network can be any type of network familiar to those skilled in the art that can support data communications using any of a variety of commercially-available protocols, including without limitation TCP/IP, SNA, IPX, AppleTalk, and the like. Merely by way of example, the network 410 can be a local area network (“LAN”), including without limitation an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine-readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine-readable mediums for storing information. The term “machine-readable medium” includes, but is not limited to portable or fixed storage devices, optical storage devices, wireless channels and/or various other mediums capable of storing, containing or carrying instruction(s) and/or data.

Having described several embodiments, it will be recognized by those of skill in the art that various modifications, alternative constructions, and equivalents may be used without departing from the spirit and scope of the invention. Additionally, a number of well known processes and elements have not been described in order to avoid unnecessarily obscuring the present invention. Accordingly, the above description should not be taken as limiting the scope of the invention, which is defined in the following claims.

What is claimed is:

1. A method of administering a loan, comprising:
determining to approve a loan application for the loan to a consumer;
using a money transfer network to make loan proceeds associated with the loan available to a recipient of the loan; and
paying out at least a portion of the loan proceeds to the recipient.

2. The method of claim 1, wherein using the money transfer network to make loan proceeds associated with the loan available to the recipient occurs at any of a plurality of money transfer agent locations, wherein a money transfer agent location comprises a physical location at which senders provide funds for transfer to receivers and/or receivers receive funds transferred from senders.

3. The method of claim 2, wherein paying out at least a portion of the loan proceeds to the recipient occurs at one of the plurality of money transfer agent locations.

4. The method of claim 1, wherein determining to approve a loan application for a loan to a consumer comprises using alternative criteria to underwrite the loan, the alternative criteria comprising data indicative of the consumer's past usage of non-credit products or services.

5. The method of claim 1, wherein determining to approve a loan application for a loan to a consumer comprises determining to approve the loan application for the loan to the consumer in the absence of a credit score relating to the consumer.

6. The method of claim 1, wherein the recipient comprises the consumer.

7. The method of claim 1, wherein the recipient comprises an individual other than the consumer.

8. The method of claim 1, further comprising receiving the loan application at a first money transfer agent location and paying out the loan proceeds at a second money transfer agent location.

9. The method of claim 8, wherein the first money transfer agent location and the second money transfer agent location comprise the same location.

10. The method of claim 1, further comprising:
thereafter, receiving a loan payment into the money transfer network; and
transferring at least a portion of the loan payment using the money transfer network to a lender of the loan proceeds.

11. The method of claim 10, wherein the third money transfer agent location comprises a different money transfer agent location than either the first money transfer agent location or the second money transfer agent location.

12. A method of lending money to a consumer using a money transfer network, comprising:
receiving a loan application from the consumer, wherein receiving the loan application comprises entering information from the loan application into a computer system, the information at least including identifying information that identifies the consumer;
using the identifying information to search stored data and extract prior usage data indicative of the consumer's prior use of the money transfer network;
using the prior usage data to, at least in part, approve the loan application;
introducing loan proceeds associated with the loan application into the money transfer network for receipt by a recipient; and
paying out at least a portion of the loan proceeds to the recipient.

13. The method of claim 12, wherein receiving the loan application from the consumer occurs at a first money transfer agent location, and wherein introducing loan proceeds associated with the loan application into the money transfer network for receipt by a recipient occurs at a second money transfer agent location.

14. The method of claim 13, wherein the first money transfer agent location and the second money transfer agent location comprise the same location.

15. The method of claim 13, wherein the first and second money transfer agent locations are in different countries.

16. The method of claim 12, thereafter, receiving a loan payment at a third money transfer agent location; and
transferring at least a portion of the loan payment using the money transfer network to a lender of the loan proceeds.

17. The method of claim 16, wherein the third money transfer agent location comprises a different money transfer agent location than either the first money transfer agent location or the second money transfer agent location.

18. A method of lending money, comprising:
receiving a loan application from a consumer, wherein the consumer is a prior customer of a money transfer service provider;
using information indicative of the consumer's prior usage of services provided by or through the money transfer service provider to approve the loan application; and
using a money transfer network to provide loan proceeds to the consumer or a designee of the consumer and/or transfer loan payments associated with the loan application.

19. The method of claim 18, wherein using information indicative of the consumer's prior usage of services provided by or through the money transfer service provider to approve the loan application comprises approving the loan in the absence of a credit report on the consumer.

20. The method of claim 18, further comprising using the consumer's usage history of pre-paid accounts serviced by the money transfer service provider to approve the loan application.
